(19) United States
(12) Patent Application Publication
(10) Pub. No.: US 2026/0098732 A1
(43) Pub. Date: Apr. 9, 2026

(54) Method for Predicting a Trajectory of a Vehicle

(71) Applicant: Robert Bosch GmbH, Stuttgart (DE)

(72) Inventors: Silas Klug, Magstadt (DE); Alessandro Moia, Holzgerlingen (DE); Fabian Immel, Pforzheim (DE)

(21) Appl. No.: 19/114,450

(22) PCT Filed: Sep. 22, 2023
(86) PCT No.: PCT/EP2023/076289

§ 371 Date: Mar. 23, 2025

(30) Foreign Application Priority Data
Sep. 27, 2022 (DE) 10 2022 210 177.4

(51) Int. Cl. G01C 21/30; G07C 5/04

(52) U.S. Cl. CPC G01C 21/30; G07C 5/04

(57) ABSTRACT

A method for predicting a trajectory of a vehicle, in particular a single-track vehicle such as an electric bike, includes (i) receiving map information from a predetermined area around the current location of the vehicle, (ii) determining a road network based on the received map information, (iii) determining one or more possible paths of the vehicle based on the determined road network, (iv) determining a kinematic trajectory of the vehicle and/or a state of the vehicle based on at least one of the variables of linear acceleration, angular acceleration, yaw rate, speed, direction, orientation, position, driver cadence and/or drive torque of the vehicle, driver drive torque, (v) determining one or more possible trajectories of the vehicle based on the one or more determined paths, and (vi) estimating, based on the determined kinematic trajectory and/or the determined state, at least one probability of the one or more possible trajectories being followed by the vehicle.

The invention relates to a method for predicting a trajectory of a vehicle, in particular a single-track vehicle such as an electric bike.

The invention also relates to a vehicle, in particular a single-track vehicle such as an electric bike, configured to predict a trajectory of the vehicle.

Although generally applicable to any vehicles, the present invention is explained with reference to electric bikes.

### PRIOR ART

In order to avoid collisions, vehicles that transmit their expected trajectory to other road users so that they can adjust their own trajectory based on it are known. To do so, the vehicles estimate their trajectory based on, for example, the current speed or orientation of the vehicle. It is also possible for the vehicles to estimate whether they are on a collision course with another road user based on their own trajectory and be able to issue corresponding warnings to a driver.

Likewise, estimating the trajectory using a kinematic model in connection with sensor data is also known. In this way, the short-term trajectory of the vehicle may be estimated with a high likelihood of the estimate being correct. Medium-term trajectories are primarily based on the driver's intention, for example, the path he or she wants to travel. This cannot be determined solely based on the state of the vehicle.

### DISCLOSURE OF THE INVENTION

In one embodiment, the present invention provides a method for predicting a trajectory of a vehicle, in particular a single-track vehicle such as an electric bike, comprising the steps of:
receiving map information from a predetermined area around the current location of the vehicle,
determining a road network based on the received map information,
determining one or more possible paths of the vehicle based on the determined road network,
determining a kinematic trajectory of the vehicle and/or a state of the vehicle based on at least one of the variables of linear acceleration, angular acceleration, yaw rate, speed, direction, orientation, position, driver cadence, drive torque of the vehicle, driver drive torque,
determining one or more possible trajectories of the vehicle based on the one or more determined paths, and
estimating, based on the determined kinematic trajectory and/or the determined state, at least one probability of the one or more possible trajectories being followed by the vehicle.

In one embodiment, the present invention provides a vehicle, in particular a single-track vehicle such as an electric bike, configured to predict a trajectory of the vehicle, comprising:
a receiving device configured to receive map information from a predetermined area around the current location of the vehicle,
a first determining means configured to determine a road network based on the received map information,
a second determining means configured to determine one or more possible paths of the vehicle based on the determined road network,
a first determining means configured to determine a kinematic trajectory of the vehicle and/or a state of the vehicle based on at least one of the variables of linear acceleration, angular acceleration, yaw rate, speed, direction, orientation, position, driver cadence, drive torque of the vehicle, driver torque,
a second determining means configured to determine one or more possible trajectories of the vehicle based on the one or more determined paths, and
an estimation device configured to estimate at least one probability of the one or more possible trajectories being followed by the vehicle using the determined kinematic trajectory and/or the determined state.

One of the advantages achieved is that even long trajectories of the vehicle can be predicted with a high level of probability. Another advantage is that the map information can be combined with the kinematic trajectory to reliably determine trajectories.

The term “trajectory” is to be understood in its broadest sense and refers, in particular in the claims, and preferably in the description to an expected route along which the vehicle will travel. In particular, a trajectory includes a number of waypoints with associated times, wherein it is assumed that the vehicle will be at the respective waypoints at these times.

The term “kinematic trajectory” is to be understood in the broadest sense and refers, in particular in the claims and preferably in the description, to a trajectory that only depends on the current state of the vehicle-that is, physical variables that describe the driving state of the vehicle-for example the speed, the yaw rate and the acceleration of the vehicle. Environmental influences, such as the course of the road on which the vehicle is located, are not considered.

The term “linear acceleration” is to be understood in the broadest sense and refers, in particular in the claims, and preferably in the description to an acceleration parallel to the direction of travel of the vehicle.

Further features, advantages and other embodiments of the invention are described in the following or are thereby disclosed.

According to one advantageous further development of the invention, at least one of the variables of speed, linear acceleration, angular acceleration, direction, yaw rate, position, drive torque, driver torque, position, and orientation of the vehicle are used to determine the one or more possible paths. An advantage of this is that the determined possible paths can be specified more accurately. For example, the determined possible paths may not have tight curves when the speed of the vehicle is high.

According to an advantageous further development of the invention, the at least one probability is estimated based on a cross-correlation of the possible trajectories with the kinematic trajectory. A cross-correlation here is a comparison of two trajectories to identify similar paths of the trajectories, in particular a correlation between the two paths of the trajectories is determined. Those trajectories that are similar to those of the kinematic trajectory are more likely to actually be driven by the vehicle. This connection can be determined by cross-correlation, allowing the probability to be estimated more accurately.

According to an advantageous further development of the invention, the one or more possible trajectories comprise the kinematic trajectory. One possible trajectory may be the kinematic trajectory, for example, when the driver is driving through a field rather than along a road. In this way, a greater number of possible trajectories may be determined.

According to an advantageous further development of the invention, the one or more trajectories are determined based on physical boundary conditions. Possible physical boundary conditions are, for example, a turning radius that is too small or an acceleration that is too high. In this way, a plausibility check of the trajectories may be carried out so that physically implausible trajectories are not determined or, respectively, so the determined trajectories are physically possible.

According to an advantageous further development of the invention, the one or more trajectories are determined based on the kinematic trajectory. This improves the accuracy of the trajectories because the current status of the vehicle is included. For example, this may make it possible to estimate the times at which the vehicle will be located at waypoints along the trajectory.

According to an advantageous further development of the invention, the one or more paths are determined using parametrically modeled curves, in particular, Bézier curves. Roads may have sharp corners, bends, or angles in their path, so that the road network also has corners, bends, or angles accordingly. Thus, determined paths within the road network could also have corners or the like, for example, when a path is determined along which the vehicle turns. Bézier curves can be used to smooth out these-unrealistic-paths, so that the determined paths reflect the real-world path more realistically. As a result, the determined paths have a lower deviation from the physically possible trajectories of the vehicle.

According to an advantageous further development of the invention, the one or more trajectories are determined using a machine learning model and/or the probabilities are estimated using the machine learning model. In particular, medium-term trajectories will depend in particular on the driver's intentions. The driver's intention may depend on the road network, for example, he or she may turn at an intersection. To do so, he or she would slow the vehicle down and possibly already slightly change the direction of the vehicle. Thus, there is a correlation between the road network, the current state of the vehicle, and the expected trajectory. By means of a machine learning model, this context can be recognized and thus the machine learning model can be trained to calculate expected trajectories based on the road network and the state of the vehicle. In so doing, the machine learning model may calculate both the trajectories and associated probabilities. One advantage of this is that trajectories can be reliably determined.

According to an advantageous further development of the invention, the machine learning model is provided as an input variable of the one or more possible paths and/or a state of the vehicle. Starting from the possible paths determined through the road network as well as the state of the vehicle, for example the speed, possible trajectories and associated probabilities can be determined using the machine learning model. By doing so, the machine learning model may effectively determine possible trajectories. It is also possible for the machine learning model to be provided with the kinematic trajectory as an input variable, either additionally or as an alternative to the state of the vehicle.

According to an advantageous further development of the invention, an acceleration and/or yaw rate profile is calculated using the machine learning model. The machine learning model may comprise an acceleration and/or yaw rate profile as a starting variable. An acceleration and/or yaw rate profile includes expected accelerations and/or yaw rates of the vehicle at multiple future points in time. Possible trajectories may be determined starting from these variables. An advantage of this is that the possible trajectories can be determined in a simple manner.

According to an advantageous further development of the invention, the one or more trajectories are determined using the acceleration and/or yaw rate profile as well as a kinematic model. For example, the kinematic model may include physical boundaries so that the possible trajectories are realistically drivable. Moreover, an initial yaw rate may be used to calculate the possible trajectories.

Further important features and advantages of the invention can be seen from the dependent claims, from the drawings and from the associated description of the figures.

It goes without saying that the aforementioned features and the features yet to be explained in the following can be used not only in the respectively specified combination, but also in other combinations or on their own, without leaving the scope of the present invention.

Preferred designs and embodiments of the present invention are shown in the drawings and are explained in more detail in the following description.

Shown in schematic form are:

FIG. 1 steps of a method according to one embodiment of the present invention;

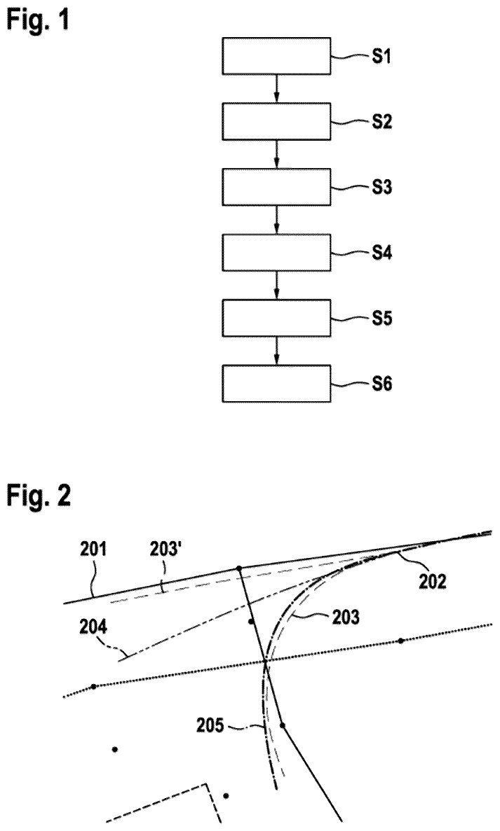

FIG. 2 a road network with trajectories according to one embodiment of the present invention,

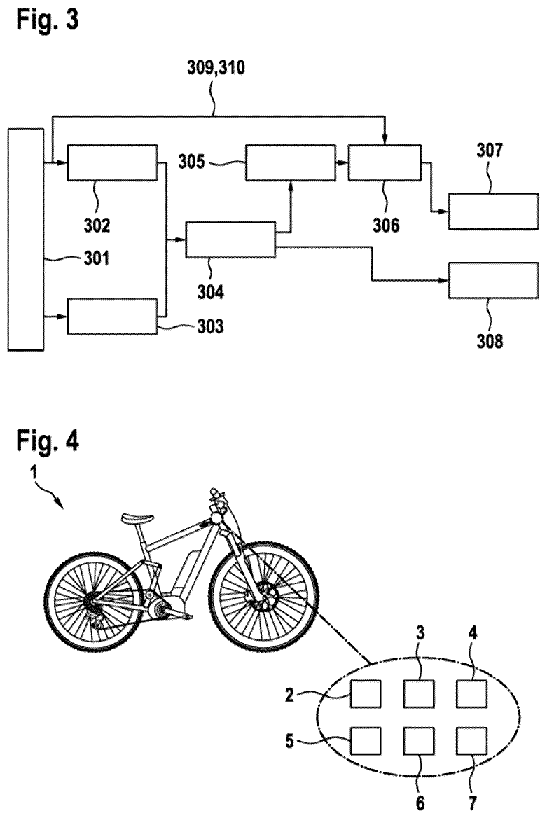

FIG. 3 A system of a machine learning model according to an embodiment of the present invention, and

FIG. 4 a vehicle according to one embodiment of the present invention.

FIG. 1 schematically shows steps of a method according to an embodiment of the present invention.

In FIG. 1, steps of a method for predicting a trajectory of a vehicle are described. In a first step S1, the vehicle receives map information from a pre-determinable area around the current position of the vehicle. For example, the map information may be stored in the vehicle or provided via a wireless interface. Because the trajectory of the vehicle is predicted for only a few seconds, a local excerpt of the map around the current position of the vehicle may be utilized, for example, a perimeter of 50 meters. The current position of the vehicle can be determined, for example using a GPS receiver.

The map information may include additional irrelevant data, such as marked buildings. Therefore, in a second step S2, a road network is determined based on the received map information. In particular, the road network includes information about the path of the roads in the surrounding area of the vehicle, as well as possibly the width of the roads.

Starting from the road network, one or more possible paths of the vehicle are determined in a third step S3. The paths describe possible routes that the vehicle can traverse. For example, the vehicle could turn at an intersection or continue straight. The state of the vehicle, for example, may be utilized to determine the paths. For example, in a curve, a radius of the trajectory may be increased when the speed of the vehicle is high. Streets usually meet at an angle. Correspondingly, paths determined in the road network could also be angular. However, such angular path is in reality not drivable by a vehicle. Therefore, the paths may be determined by way of Bézier curves, such that the paths do not have sharp angles.

In a fourth step S4, a kinematic trajectory of the vehicle and/or a state of the vehicle is determined based on at least one of the variables of linear acceleration, angular acceleration, yaw rate, speed, direction, orientation, position, driver cadence, drive torque of the vehicle, driver drive torque. The kinematic trajectory corresponds to the trajectory that the vehicle would traverse if it were to continue according to the current state, for example at the same speed or in the same direction.

In a fifth step S5, one or more possible trajectories of the vehicle are determined based on the one or more determined paths. To determine the possible trajectories, the determined paths may be combined with the kinematic trajectory. In this way, it is possible to determine the points in time at which the vehicle will be at waypoints of the path. It is also possible for the paths to be adjusted based on the kinematic trajectory in order to thus obtain the possible trajectories. In addition, the trajectories may be adjusted with respect to physical restrictions, for example a maximum speed in a curve. It is also possible that the possible trajectories may be determined using a machine learning model. In this way, a group of possible trajectories is obtained, wherein the kinematic trajectory is also part of the group. For example, the possible paths and/or the possible trajectories may be determined using a Kalman filter.

In a sixth step S6, at least one probability of the vehicle following the one or more possible trajectories is estimated by way of the determined kinematic trajectory and/or state. By cross-correlation of the possible trajectories with the kinematic trajectory, or using the machine learning model, the probabilities of the vehicle traveling along a particular trajectory can be estimated.

FIG. 2 schematically shows a road network with trajectories according to one embodiment of the present invention.

The road network 201 shows the paths of the roads. Starting from the start point 202 of the vehicle, three trajectories are determined. The two possible trajectories 203, 203 are determined by way of the Bezier curves and the state of the vehicle, for example the speed, the yaw rate, the position and the direction of the vehicle, wherein the starting point of the vehicle is the starting point of the Bezier curves. The kinematic trajectory 204 shows the expected path of the vehicle if the road network is disregarded. Based on a correlation of the kinematic trajectory 204 with the possible trajectories 203, 203, the probabilities that the vehicle will follow the possible trajectories 203, 203 may be calculated. The actual trajectory 205 of the vehicle is similar to the possible trajectory 203. Thus, the vehicle follows approximately one of the possible trajectories 203, 203′.

FIG. 3 schematically shows a system of a machine learning model according to an embodiment of the present invention.

The input 301 of the system comprises a group of possible paths that a vehicle can take and the state of the vehicle. The possible paths can be determined, for example according to step S3 pursuant to FIG. 1 and the state can be determined, for example according to step S4 pursuant to FIG. 1. A kinematic trajectory may also be utilized. Using a path encoder 302, the possible paths are encoded so that they can be used as the input variable for the neural network 304. Analogously, the state of the vehicle is converted to an input variable for the neural network 304 by a state encoder 303.

The neural network 304 calculates a future acceleration and/or yaw rate profile and/or yaw rate deviation profile 305. Starting from this, a group of possible trajectories 307 is calculated by a kinematic model 306 and taking into account an initial yaw rate 309 as well as the possible paths. In particular, the kinematic model 306 comprises physical boundary conditions of the vehicle, such as a maximum speed or minimum turning radius, such that the group of calculated trajectories 307 is realistic. In addition, the kinematic model 306 can be used to reduce the deviation of the group of trajectories 306 from the possible paths 310. The neural network 304 may have been trained based on traveled paths.

Further, a group of probabilities 308 that the vehicle will travel along the respective trajectories may be calculated by the neural network 304.

FIG. 4 shows in schematic form a vehicle according to one embodiment of the present invention.

The vehicle 1, here in the form of an electric bike, is configured to predict a trajectory of the vehicle 1. To this end, the vehicle 1 comprises:
a receiving device 2 configured to receive map information from a predetermined area around the current position of the vehicle 1,
a first determining means 3 configured to determine a road network based on the received map information,
a second determining means 4 configured to determine one or more possible paths of the vehicle 1 based on the determined road network,
a first determining means 5 configured to determine a kinematic trajectory of the vehicle 1 and/or a state of the vehicle 1 based on at least one of the variables linear acceleration, angular acceleration, yaw rate, speed, direction, orientation, position, driver cadence, drive torque of the vehicle 1, driver torque,
a second determining means 6 configured to determine one or more possible trajectories of the vehicle 1 based on the one or more determined paths, and
an estimation device 7 configured to estimate probabilities that the vehicle 1 will follow the one or more possible trajectories using the kinematic trajectory and/or the state.

In particular, the vehicle 1 is configured to perform the steps S1 through S6 as shown in FIG. 1.

Even though the present invention has been described with reference to preferred exemplary embodiments, it is not limited to these and can be modified in a variety of ways.

1. A method for predicting a trajectory of a vehicle, comprising
receiving map information from a pre-determined area around the current position of the vehicle,
determining a road network based on the received map information,
determining one or more possible paths of the vehicle based on the determined road network,
determining a kinematic trajectory of the vehicle and/or a state of the vehicle based on at least one of the variables of linear acceleration, angular acceleration, yaw rate, speed, direction, orientation, position, driver cadence, and/or drive torque of the vehicle, and driver drive torque,
determining one or more possible trajectories of the vehicle based on the one or more determined paths, and
estimating at least one probability of the one or more possible trajectories being followed by the vehicle using the determined kinematic trajectory and/or the determined state.

2. The method according to claim 1, wherein at least one of the variables of speed, linear acceleration, angular acceleration, direction, yaw rate, position, drive torque, driver torque, position, and orientation of the vehicle are utilized to determine the one or more possible paths.

3. The method according to claim 1, wherein the at least one probability is estimated from a cross correlation of the possible trajectories with the kinematic trajectory.

4. The method according to claim 1, wherein the one or more possible trajectories comprise the kinematic trajectory.

5. The method according to claim 1, wherein the one or more trajectories are determined based on physical boundary conditions.

6. The method according to claim 3, wherein the one or more trajectories are determined based on the kinematic trajectory.

7. The method according to claim 1, wherein the one or more paths are determined using parametrically modeled curves.

8. The method according to claim 1, wherein the one or more trajectories are determined using a machine learning model and/or the probabilities are estimated using the machine learning model.

9. The method according to claim 8, wherein the one or more possible paths and/or a state of the vehicle are provided to the machine learning model as an input variable.

10. The method according to claim 8, wherein an acceleration and/or yaw rate profile is calculated using the machine learning model.

11. The method according to claim 10, wherein the one or more trajectories are determined based on the acceleration and/or yaw rate profile as well as a kinematic model.

12. A vehicle comprising:
a receiving device configured to receive map information from a pre-determined area around the current position of the vehicle,
a first determining means configured to determine a road network based on the received map information,
a second determining means configured to determine one or more possible paths of the vehicle based on the determined road network,
a first determining means configured to determine a kinematic trajectory of the vehicle and/or a state of the vehicle based on at least one of the variables of linear acceleration, angular acceleration, yaw rate, speed, direction, orientation, position, driver cadence, drive torque of the vehicle, and driver torque,
a second determining means configured to determine one or more possible trajectories of the vehicle based on the one or more determined paths, and
an estimation device configured to estimate at least one probability of the one or more possible trajectories being followed by the vehicle using the determined kinematic trajectory and/or the determined state.

13. The method according to claim 1, wherein the vehicle is a single track vehicle.

14. The method according to claim 13, wherein the single track vehicle is an electric bike.

15. The method according to claim 7, wherein the parametrically modeled curves include Bézier curves.

16. The vehicle according to claim 12, wherein the vehicle is a single track vehicle.

17. The vehicle according to claim 16, wherein the single track vehicle is an electric bike.
